(19) United States
(12) Patent Application Publication
(10) Pub. No.: US 2018/0249726 A1
(43) Pub. Date: Sep. 6, 2018

(54) PROCESS FOR PRODUCING A MILK PRODUCT FREE OF LACTOSE

(71) Applicant: DMK Deutsches Milchkontor GmbH, Zeven (DE)

(72) Inventors: Sven-Rainer Döring, Zeven (DE); Thorben Oehlckers, Buchholz (DE); Jan Aschemann, Zeven (DE)

(21) Appl. No.: 15/448,896

(22) Filed: Mar. 3, 2017

(51) Int. Cl. A23C 9/12; A23C 9/142

(52) U.S. Cl. CPC A23C 9/1206; A23C 9/1422

(57) ABSTRACT

Provided is a process for producing milk products free or at least substantially free of lactose (lactose content less than 0.1% b.w.) which includes a combination of a specific heat treatment, filtration, recombination of permeates and retentates thus obtained and optionally hydrolyzation of lactose by lactase.

### FIELD OF INVENTION

The invention relates to a process for producing milk products, in particular so-called standard milk, free or substantially free of lactose.

### BACKGROUND OF THE INVENTION

During their lactation newborn mammals form the enzyme lactase, which cleaves the disaccharide milk sugar (“lactose”) into the metabolism utilizable sugars D-galactose and D-glucose. In the course of natural weaning from the mother's milk, the activity of the lactase decreases to about 5 to 10% of the activity at birth. This is true for humans and all other mammals. Only in populations which have been involved in dairy farming for a long time a mutation has been established, which leads to the production of lactase even in adulthood (lactase persistence). This is probably due to the fact that the higher lactase activity offered a selection advantage (minerals, nutritional value) for these groups.

In the case of deficient lactase activity, lactose reaches the intestine, where it is taken up and fermented by intestine bacteria. Fermentation products are lactic acid as well as methane and hydrogen. The gases lead, among other things, to flatulence, while the osmotically active lactic acid causes an inflow of water into the intestine (osmotic diarrhea).

In Asia and Africa, the lack of lactase persistence or lactose intolerance affects most of the adult population (90% or more), in Western Europe, Australia and North America, it is 5-15% (for light-skinned people) 15-25% of the total population are affected by lactose intolerance. The reason for lactose intolerance is congenital enzyme deficiencies, in which the corresponding enzymes are missing, which split the milk sugar into its individual parts. In recent years, at least the awareness of a relationship between the mentioned symptoms with the presence of lactose, especially in dairy products has grown strongly. This has led to a great need for lactose-poor or better lactose-free products.

Various processes are known from the prior art with the aid of which lactose is either separated off from milk products and further processed as a by-product or degraded by appropriate enzymes.

EP 1503630 B1 (VALIO) is, for example, a process for the preparation of lactose-free products, in which the starting milk is first subjected to ultrafiltration. The resulting first permeate is nanofiltrated, the lactose being discharged through the second retentate and the monovalent salts (sodium, potassium) entering the second permeate. This is concentrated by means of a reverse osmosis and the third retentate so obtained is re-mixed with the first retentate before this is then subjected to hydrolysis in order to enzymatically decompose the lactose. However, the process has two major disadvantages: the lactose content of the retentate which is hydrolyzed cannot be controlled, but is automatically set to a very low value because of the conditions in the ultrafiltration. In the hydrolysis, only small amounts of sugar are then available for the cleavage, so that lactose-free milk is obtained, which, however, is far less sweet and tasteappealing than the starting milk. In addition, only alkaline salts enter the milk through the process. In order to achieve the taste profile of the source milk again, divalent salts from other sources have to be re-added. In sum, a product is obtained which corresponds only approximately to the desired taste profile of the starting milk.

A similar route is proposed in EP 2207428 B1 (ARLA): here the milk is also first subjected to an ultrafiltration, permeate being then subjected to nanofiltration. Permeate obtained from the nanofiltration is mixed with the retentate from the ultrafiltration and then hydrolyzed. However, this method has the same disadvantages as the Valio method with respect to the taste profile of the resulting products.

US 2013 014904 A1 (ARLA) describes a process for producing dairy products low in lactose content, according to which raw milk is subjected to an ultra-high temperature treatment at 150° C. and over a few milliseconds. The purpose, however, is an improved pasteurization.

WO 2008 000895 A1 (VALIO) describes a process for making sour milk products low or even free of lactose, by adding lactase to the raw milk. After hydrolyzation of the lactose the enzyme is deactivated by a heat treatment over 5 minutes at 95° C.

US 2011 00599220 A1 (VALIO) also refers to lactose-free milk products by blending specific milk fractions obtained from different filtration step. The process includes a standard pasteurization step at a temperature of at least 72° C.

WO 2012 056106 A1 (VALIO) suggests to eliminate lactose by means of lactase and subsequently adding proteases. The document does not disclose any heat treatment of the raw milk.

EP 2050341 A1 (SHANGHAI SHANGLONG DAIRY CO.) discloses a conventional preparation of milk comprising a pasteurization step which, according to example 1 is conducted at 61° C. over a period of 30 minutes.

The object of the present invention, therefore, was to provide lactose-depleted milk composition or essentially lactose-free milk from whole milk, skimmed milk or standardized milk, which typically contains between 4 and 5% by weight of lactose, which, however, has the same or substantially identical mineral composition as the starting milk so as to be able to produce lactose-free products whose taste profile corresponds to the starting milk.

### SUMMARY OF THE INVENTION

In one aspect, there is provided a process for producing milk products free or at least substantially free of lactose (lactose content less than 0.1% b.w.) which includes a combination of a specific filtration step, recombination of permeates and retentates thus obtained and optionally hydrolyzation of lactose by means of lactase.

Further to this, all these alternatives encompass one unifying feature that is a step conducted either on the level of the raw milk or on the level of the raw milk which was subjected to a partial hydrolysis of its lactose content. This step is a specific heat treatment of the milk that takes place within a certain temperature range and over a specific period of time.

### BRIEF DESCRIPTION OF THE DRAWINGS

The invention will be better understood with reference to the detailed description when considered in conjunction with the non-limiting examples and the accompanying drawings, in which:

FIG. 1 reflects process alternative (a) encompassing the steps of precipitation, ultrafiltration, nanofiltration, decalcification, mixing and optionally hydrolysis.

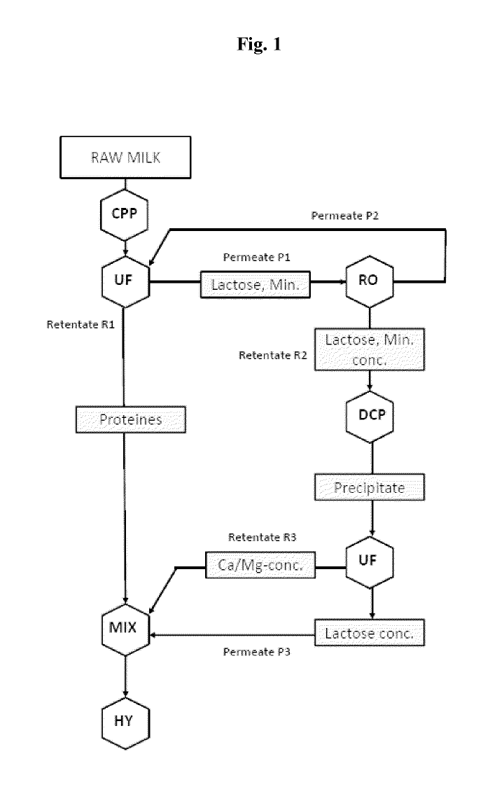

FIG. 2 shows alternative (b) comprising the steps of hydrolysis, precipitation, nanofiltration, reverse osmosis, mixing and optionally a second hydrolysis.

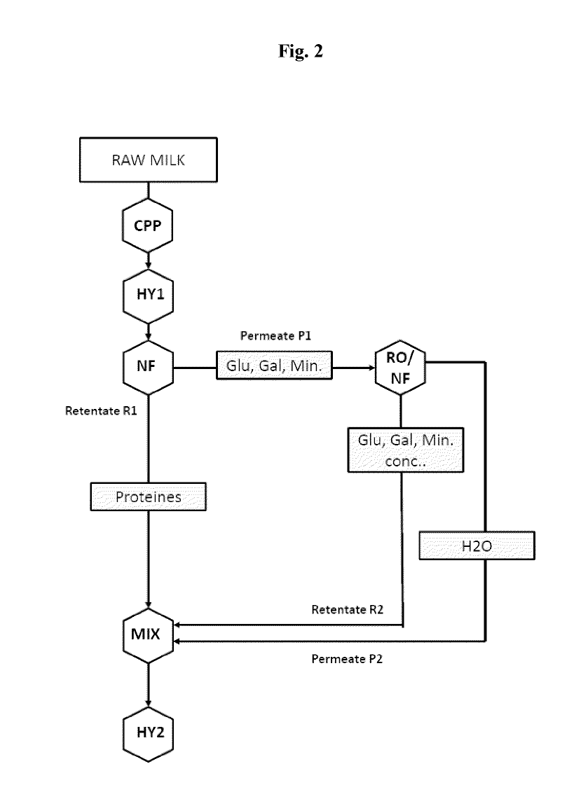

FIG. 3 exhibits alternative (c) encompassing the steps of precipitation, ultrafiltration, nanofiltration, mixing and optionally a second hydrolysis.

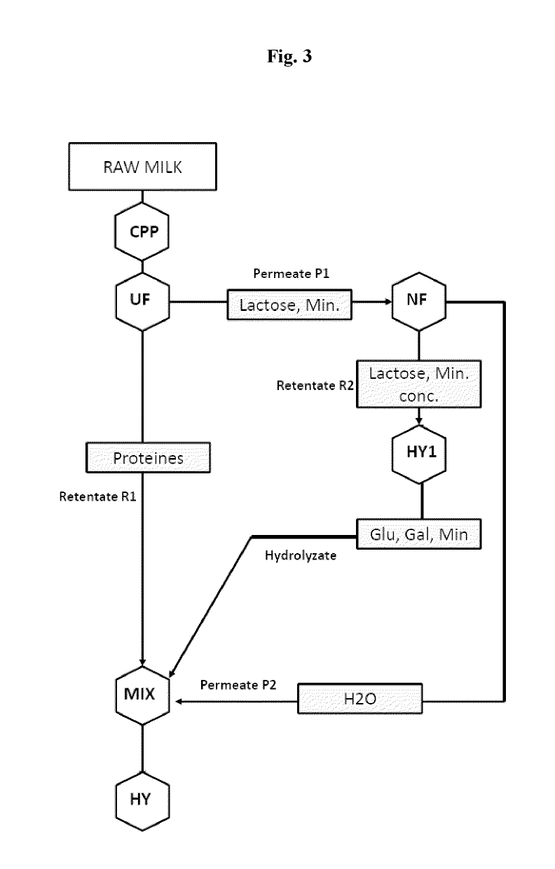

The references in the figures have the following meanings:
CPP=Calcium precipitation process
NF=Nanofiltration
UF=Ultrafiltration
RO=Reverse osmosis
DCP=Decalcification
MIX=Mixing
HY=Hydrolysis
Glu=Glucose
Gal=Galactose
Min=Minerals

### DETAILED DESCRIPTION OF THE INVENTION

The present invention is directed to a process for producing a milk product free of lactose encompassing the following steps:
(a1) heating raw milk over a period of 5 to 25 minutes at a temperature of from 55 to 65° C. to produce an intermediate;
(a2) subjecting said intermediate of step (a1) to a first ultrafiltration to produce a first permeate UFP1 and a first retentate UFR1;
(a3) subjecting said first permeate UFP1 to reverse osmosis to produce a second permeate ROP2 and a second retentate ROR1;
(a4) subjecting second retentate ROR1 to decalcification;
(a5) subjecting said decalcification product of step (a4) to a second ultrafiltration to produce a third permeate UFP3 rich in lactose and a third retentate UFR3 rich in minerals,
(a6) mixing said first retentate UFR1 with such amount of said third permeate UFP3 to produce standard milk showing a lactose content of less than 0.1% b.w. and a mineral and protein content similar to said raw milk; and optionally
(a7) subjecting said standard milk of step (a6) to hydrolysis by addition of lactase in an amount sufficient to convert all remaining lactose into glucose and galactose;
   or
(b1) subjecting standard milk to hydrolysis by addition of lactase in an amount sufficient to convert about 25 to about 90% of its lactose content into glucose and galactose;
(b2) heating said hydrolyzation product of step (b1) over a period of 5 to 25 minutes at a temperature of from 55 to 65° C. to produce an intermediate;
(b3) subjecting said intermediate to nanofiltration to produce a first permeate NFP1 and a first retentate NFR1;
(b4) subjecting said first permeate NFP1 either to reverse osmosis or another nanofiltration to produce a second permeate RO/NFP1 and a second retentate RO/NFR2;
(b5) mixing said first retentate NFR1 with such amount of said third permeate RO/NFP3 to produce standard milk showing a lactose content of less than 0.1% b.w. and a mineral and protein content similar to said raw milk; and optionally
(b7) subjecting said standard milk of step (a6) to hydrolysis by addition of lactase in an amount sufficient to convert all remaining lactose into glucose and galactose;
   or
(c1) heating raw milk over a period of 5 to 25 minutes at a temperature of from 55 to 65° C. to produce an intermediate;
(c2) subjecting said intermediate of step (a1) to a first ultrafiltration to produce a first permeate UFP1 and a first retentate UFR1;
(c3) subjecting said first permeate UFP1 to nanofiltration to produce a second permeate NFP2 and a second retentate NFR1;
(c4) subjecting said second retentate NFR1 to hydrolysis by adding lactase in an amount sufficient to convert about 25 to about 90% of its lactose content into glucose and galactose;
(c5) mixing said first retentate UFR1 with such amount of said second permeate NFP2 and said hydrolyzation product of step (c4) to produce standard milk showing a lactose content of less than 0.1% b.w. and a mineral and protein content similar to said raw milk; and optionally
(c6) subjecting said standard milk of step (c5) to hydrolysis by addition of lactase in an amount sufficient to convert all remaining lactose into glucose and galactose.

Surprisingly, it has been found that under the conditions defined above a large portion, in particular more than 50% by weight, preferably from about 80 to about 95% by weight, of the calcium freely dissolved in the milk precipitates and forms larger particles by means of a targeted heat pretreatment, which remain in the retentate in subsequent filtration steps. The resulting products have a markedly improved taste compared to those without precipitation step.

This step is decisive for the taste suitability of all subsequently produced dairy products which are lactose-free or substantially lactose-. By “lactose-free” or “substantially lactose-free” is understood that the content of lactose in the final product is less than 0.1% by weight and in particular less than 0.01% by weight.

### Alternative A

In a first embodiment of the present invention, a process for the production of lactose-free or substantially lactose-free products is claimed which comprises the following steps:
(a1) heating raw milk over a period of 5 to 25 minutes at a temperature of from 55 to 65° C. to produce an intermediate;
(a2) subjecting said intermediate of step (a1) to a first ultrafiltration to produce a first permeate UFP1 and a first retentate UFR1;
(a3) subjecting said first permeate UFP1 to reverse osmosis to produce a second permeate ROP2 and a second retentate ROR1;
(a4) subjecting second retentate ROR1 to decalcification;
(a5) subjecting said decalcification product of step (a4) to a second ultrafiltration to produce a third permeate UFP3 rich in lactose and a third retentate UFR3 rich in minerals,
(a6) mixing said first retentate UFR1 with such amount of said third permeate UFP3 to produce standard milk showing a lactose content of less than 0.1% b.w. and a mineral and protein content similar to said raw milk; and optionally
(a7) subjecting said standard milk of step (a6) to hydrolysis by addition of lactase in an amount sufficient to convert all remaining lactose into glucose and galactose;

This embodiment of the invention, which also includes step (a7), therefore relates to the case that the lactose content in the milk is ultimately zero.

In the context of this method variant, the milk is first separated into a protein-rich/lactose-poor fraction and a proteomic/lactose-rich fraction, the latter being concentrated first and separated into a salt concentrate and a lactose concentrate, and the two concentrates of the first protein-rich/lactose depleted (“Standardization”) in such amounts that the composition of the starting milk again results, but the amount of lactose is markedly reduced. Preferably, the lactose content is adjusted to about a quarter of the initial value during the back mixing. During the subsequent hydrolysis the lactose decomposes into molecule glucose and a molecule galactose. Studies on the relative sweetness (rS) of different carbohydrates relative to sucrose (according to Noeske, 1996) showed that both glucose (rS=64) and galactose (rS=60) each have about twice the sweetening power compared to lactose (rS=30) respectively. If, therefore, the amount of lactose is reduced to a quarter of the initial value before hydrolysis, the amount of sugar required to produce the same sweetness of the starting milk is restored. This makes the milk not sweeter than before. In that the milk is not added to the milk during the standardization, but after hydrolysis, a product is obtained which is lactose-free, but is otherwise different in the composition from the starting milk and therefore has the same taste impression. It is, of course, also possible with the aid of the process to adjust a very low lactose content, for example by adding to the first retentate R1 no or very little lactose concentrate (permeate P3). Accordingly, an unsweetened, very low-calorie milk is obtained after the hydrolysis.

### Heat Treatment

As explained infra it is essential subjecting raw milk or its hydrolysis product to a step in which the predominant amount of calcium is precipitated before the further treatment. Preferably, the starting milk, which is typically whole milk, skimmed milk or standard milk, is subjected to a temperature treatment in the range from about 55 to about 65° C., preferably about 57 to about 60° C., the treatment time generally being between about 5 and about 25 minutes, and preferably about 10 and 20 minutes.

Under these conditions a large portion, in particular more than 50% by weight, preferably from about 80 to about 95% by weight, of the calcium freely dissolved in the milk precipitates and forms larger particles by means of a targeted heat pretreatment, which remain in the retentate in subsequent filtration steps. The resulting products have a markedly improved taste compared to those without precipitation step.

### First Ultrafiltration

In this first process step, the starting milk, which is whole milk, skimmed milk or standardized milk with a lactose content, is in the range from about 3 to about 5% by weight and preferably about 4 to about 4.5% by weight is separated into a proteinaceous and lactose-rich fraction as well as a protein and lactose-rich fraction.

Ultrafiltration belongs to the filtration processes from the field of membrane technology, with which macromolecular substances and small particles can be separated from a medium and concentrated. Microfiltration, ultrafiltration and nanofiltration are distinguished over the degree of separation. If the exclusion limit (or “cut-off”) is at 100 nm or more, this is referred to as microfiltration. If the exclusion limit is in the range from 2 to 100 nm, this is referred to as ultrafiltration. In nanofiltration, the exclusion limit is less than 2 nm. In each of these cases, it is purely physical, i.e. mechanical membrane separation methods, which work according to the principle of mechanical size exclusion: all particles in the fluids, which are larger than the membrane pores, are retained by the membrane. The driving force in the separation process is the differential pressure between inlet and outlet of the filter surface, which is between 0.1 and 10 bar.

The exclusion limits of ultrafiltration membranes are also given in the form of the NMWC (English: Nominal Molecular Weight Cut-Off, also MWCO, Molecular Weight Cut Off, unit: Dalton). It is defined as the minimum molecular mass of globular molecules which are retained by the membrane to 90%. In practice, the NMWC should be at least 20% lower than the molecular weight of the molecule to be separated. Further qualitative statements about the filtration can be made with the Flux (water value) (transmembrane flow or passage rate). In the ideal case, this is proportional to the transmembrane pressure and reciprocal to the membrane resistance. These quantities are determined both by the properties of the membrane used as well as by concentration polarization and possible fouling. The permeation rate is based on 1 m2 membrane area; the respective unit is 1/(m² h bar).

In a preferred embodiment of the process according to the invention, the ultrafiltration is carried out with the addition of such an amount of water to obtain a first retentate having a dilution factor of about 5 to about 20 and preferably about 8 to about 12. The water from the second permeate P2 of the subsequent reverse osmosis is preferably used in this connection.

For ultrafiltration, membranes having a pore diameter ranging from about 1,000 to about 50,000, and preferably about 5,000 to about 25,000 daltons, have been found to be particularly suitable. On the other hand, preference is given, for example, to the nanofiltration pore diameters in the range from 100 to 1000 and preferably about 150 to 800 daltons.

The material of the filter surface can be stainless steel, polymer materials, ceramics, aluminum oxide or textile fabrics. There are various appearances of the filter elements: candle filters, flat membranes, spiral winding membranes, pocket filters and hollow fiber modules, which are basically suitable in the sense of the present invention. However, spiral winding membranes made of polymer materials or ceramic or aluminum oxide filter filters are preferably used, the first embodiment having proved to be the most suitable for ultrafiltration and the second for nanofiltration.

For the purposes of the present invention, the ultrafiltration can be “hot” or “cold”, i.e. In the temperature range from about 4 to about 55° C. However, preference is given to working at temperatures in the low range from about 4 to about 25° C. and in particular from about 8 to about 18° C.

### Reverse Osmosis

The first permeate P 1 of the ultrafiltration is virtually free of proteins, but contains lactose and minerals in concentrations which are practically unchanged compared to the starting milk. In the following reverse osmosis, the amount of these two components is concentrated.

Reverse osmosis or reverse osmosis is a physical process for the concentration of substances dissolved in liquids, in which the natural osmosis process is reversed by pressure. The medium in which the concentration of a particular substance is to be reduced is separated by a semipermeable membrane from the medium in which the concentration is to be increased. This is subjected to a pressure which must be higher than the pressure created by the osmotic desire for concentration equalization. This allows the molecules of the solvent to migrate against their “natural” osmotic propagation direction. The process pushes it into the compartment in which solutes are less concentrated.

The osmotic membrane, which only allows the carrier liquid (solvent) to pass through and retains the solutes (solutes), must be able to withstand these high pressures. If the pressure difference more than compensates for the osmotic gradient, the solvent molecules fit like a filter through the membrane, while the remaining molecules are retained. In contrast to a classical membrane filter, osmosis-membranes do not have persistent pores. Rather, the ions and molecules migrate through the membrane, diffusing through the membrane material.

The osmotic pressure increases with increasing concentration difference. If the osmotic pressure is equal to the applied pressure, the process stops. There is then an osmotic balance. A continuous drainage of the concentrate can prevent this. At the concentrate outlet, the pressure is either controlled via a pressure regulator or via a pressure exchanger in order to build up the pressure required in the inlet of the system. Pressure exchangers reduce the operating costs of a reverse osmosis system very effectively by energy recovery. The energy consumption per cubic meter of water is 4 to 9 kWh. Preferably, the concentration factor in the process according to the invention is from about 2.5 to about 5 and more preferably from about 3 to about 4.

The crystallization (precipitation) of the solutes in the membranes must be prevented. This can be achieved by the addition of anticaking agents or acids. Antifungal agents here are polymeric compounds based on phosphate or maleic acid, which enclose the crystallites formed and thus prevent the formation of crystalline precipitates on the membrane. However, cleaning the membrane may still be necessary. To prevent damage to the membrane, filters can also be connected upstream. A fine filter can prevent chemical damage (eg by chlorine), mechanical and an activated carbon filter.

In the case of reverse osmosis, a second permeate is obtained which is essentially only water which is led back into the ultrafiltration, as well as a retentate in which lactose and minerals are concentrated and which has a dry mass on the order of about 15 to about 20% by weight.

### Decalcification

In order to obtain the divalent ions from the concentrate of reverse osmosis, the second retentate R2 is initially adjusted to an approximately neutral pH value in the range from 6 to 8 by addition of bases, and the minerals, which are essentially soluble phosphates, are reacted with An amount of a solution of a water-soluble calcium or magnesium salt is added such that insoluble Ca/Mg salts are precipitated. NaOH, an aqueous preparation of calcium/magnesium chloride and alkali metal hydroxide or calcium hydroxide are used to adjust the pH value and the precipitation. In principle, other alkali or alkaline earth bases such as, for example, KOH can be used. The nature of the precipitation salt is also not critical in itself, for example barium salts can also be precipitated. The use of calcium and magnesium salts has the advantage, however, that the precipitant is inexpensive and the salts have a very low solubility product, that is, the precipitation is essentially complete. Demineralization is also carried out in stirred kettles without the addition of precipitants, it being found to be advantageous to set a temperature in the range from about 50 to 90° C. and preferably of about 80° C. The precipitation time is typically about 10 to 60 minutes and preferably about 15 to 20 minutes, which is only indicative since lower temperatures require longer reaction times and vice versa.

### Second Ultrafiltration

The precipitate from the decalcification step is fed to a second ultrafiltration, for which basically the same process conditions apply as have already been explained above. It is preferred to carry out the ultrafiltration in the cold, but it is also possible to apply the hot precipitate to the membrane without further cooling or only after slight cooling. In this case, a third retentate R3 is obtained, in which essentially, i. To about 90% by weight of the calcium/magnesium salts and which has a dry mass of from about 8 to about 15% by weight. Similarly, a third permeate P3 is obtained which has a dry mass of about 15 to about 25% by weight, preferably about 15 to about 20% by weight, and essentially contains lactose and also the alkali salts.

### Mixing

The mixing step serves for the production of a standardized milk product which is subsequently completely freed from lactose by hydrolysis. For this purpose, defined amounts of lactose and minerals are added to the protein-rich first retentate obtained in the first step. The object is, in particular, to obtain a product which, compared with the starting milk, has only about 25% lactose, so that the same degree of sweetening is achieved after the hydrolysis. The addition of the minerals is also aimed at restoring the original salt concentration and salt composition in order to preserve the taste impression of the milk of origin

The method according to the invention is therefore further characterized in a specific embodiment by the fact that the first retentate R1
(i) adding such an amount of the lactose concentrate (permeate P3) that a lactose concentration of about 0.5 to about 2.5% by weight and preferably about 0.8 to 1.8% by weight based on The resulting standard milk, and/or
(ii) adding such an amount of the mineral concentrate (retentate R3) that a mineral concentration of from about 0.6 to about 1.0% by weight, and preferably from about 0.8 to 0.9% by weight, based on The resulting standard milk, and/or
(iii) adding such an amount of the lactose concentrate (permeate P3) and the mineral concentrate (retentate R3) so that the dilution results in a protein concentration of about 3.0 to about 10.0% by weight and preferably about 3, 5 to about 3.7% by weight, based on the resulting standard milk.

### Hydrolysis

Lactose belongs to the group of disaccharides and consists of the two molecules D-galactose and D-glucose, which are linked via a β-1,4-glycosidic bond.

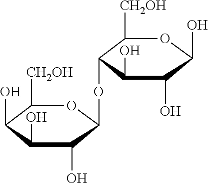

For degradation into the two sugar components, lactose is added with the enzyme lactase (also referred to as LPH or LCT). The hydrolysis is preferably carried out in a stirred tank with a continuous inlet and outlet as well as a metering device for adding the enzyme and a valve located at the bottom of the reactor for draining the activated enzyme, which sediments over time. It has been found to be advantageous to employ an effective enzyme concentration of about 180,000 to 250,000 FCC units of lactase per kg of lactose to be hydrolyzed, and the reaction is carried out at temperatures ranging from about 4 to about 65° C. and preferably in the range of 20 to 30° C. and a slightly acidic pH of about 5 to 6.

### Alternative B

In a second embodiment of the present invention, a process for the production of lactose-free or substantially lactose-free products is claimed which comprises the following steps:
(b1) subjecting standard milk to hydrolysis by addition of lactase in an amount sufficient to convert about 25 to about 100% of its lactose content into glucose and galactose;
(b2) heating said hydrolyzation product of step (b1) over a period of 5 to 25 minutes at a temperature of from 55 to 65° C. to produce an intermediate;
(b3) subjecting said intermediate to nanofiltration to produce a first permeate NFP1 and a first retentate NFR1;
(b4) subjecting said first permeate NFP1 either to reverse osmosis or another nanofiltration to produce a second permeate RO/NFP1 and a second retentate RO/NFR2;
(b5) mixing said first retentate NFR1 with such amount of said third permeate RO/NFP3 to produce standard milk showing a lactose content of less than 0.1% b.w. and a mineral and protein content similar to said raw milk; and optionally
(b7) subjecting said standard milk of step (a6) to hydrolysis by addition of lactase in an amount sufficient to convert all remaining lactose into glucose and galactose.

In a first specific embodiment of this second process variant, an amount of lactase is used in step (b1) such that the amount of lactose present in the product is completely cleaved into glucose and galactose. This means that all further processing steps are carried out with lactose-free milk whose mineral concentration and composition must still be adapted to the starting milk.

In an alternative second embodiment, the method comprises a further hydrolysis step (b7). This embodiment of the invention comes into play when, in step (b1), an amount of lactase has been used which is just not sufficient to cleave the total amount of lactose.

In the context of this second process variant, the milk is first subjected to a hydrolysis in which in each case one molecule of lactose is cleaved into a molecule of glucose and a molecule of galactose. Subsequently, the hydrolysis product is separated into a protein fraction and a carbohydrate fraction; the latter is first concentrated and then re-added to the protein fraction with the addition of water in such amounts (“standardization”) in such a way that the protein and mineral composition of the starting milk again results. Studies on the relative sweetness (rS) of different carbohydrates relative to sucrose (according to Noeske, 1996) showed that both glucose (rS=64) and galactose (rS=60) each have about twice the sweetening power compared to lactose (rS=30) respectively. Preferably, therefore, the content of glucose and galactose is adjusted to a value with which the degree of sweetening of the starting milk is achieved. In that the milk is not added to the milk during the standardization, but after hydrolysis, a product is obtained which is lactose-free, but is otherwise different in the composition from the starting milk and therefore has the same taste impression.

### Hydrolysis

Suitable starting materials are once again full-milk, skimmed milk or standardized milk with a lactose content in the range from about 3 to about 5% by weight and preferably about 4 to about 4.5% by weight. Lactose is added to the two sugar components by the enzyme lactase (also referred to as LPH or LCT). The hydrolysis is preferably carried out in a stirred tank with a continuous inlet and outlet as well as a metering device for the addition of the enzyme and a valve at the bottom of the reactor for draining the deactivated enzyme which sediments over time. It has been found to be advantageous to employ an effective enzyme concentration of about 180,000 to 250,000 FCC units of lactase per kg of lactose to be hydrolyzed, and the reaction is carried out at temperatures ranging from about 4 to about 65° C. and preferably in the range of 20 to 30° C. and a slightly acidic pH of about 5 to 6.

### First Nanofiltration

In the second process step, the hydrolysis product is separated into a protein fraction and a carbohydrate fraction. Nanofiltration belongs to the filtration processes from the field of membrane technology, with which macromolecular substances and small particles can be separated from a medium and concentrated. Microfiltration, ultrafiltration and nanofiltration are distinguished over the degree of separation. Exclusion limits (or “cut-off”) of about 100 nm or more are referred to as microfiltration. If the exclusion limit is in the range from 2 to 100 nm, this is referred to as ultrafiltration. In nanofiltration, the exclusion limit is less than 2 nm. In each of these cases, it is purely physical, i.e. Mechanic membrane separation methods, which work according to the principle of mechanical size exclusion: all particles in the fluids, which are larger than the membrane pores, are retained by the membrane. The driving force in the separation process is the differential pressure between the inlet and outlet of the filter surface, which is between 0.1 and 40 bar.

The exclusion limits of nanofiltration membranes are also given in the form of the NMWC (English: Nominal Molecular Weight Cut-Off, also MWCO, Molecular Weight Cut Off, unit: Dalton). It is defined as the minimum molecular mass of globular molecules which are retained by the membrane to 90%. In practice, the NMWC should be at least 20% lower than the molecular weight of the molecule to be separated. Further qualitative statements about the filtration can be made with the Flux (water value) (transmembrane flow or passage rate). In the ideal case, this is proportional to the transmembrane pressure and reciprocal to the membrane resistance. These quantities are determined both by the properties of the membrane used as well as by concentration polarization and possible fouling. The permeation rate is based on 1 m2 membrane area. Their unit is 1/(m2 h bar). In a preferred embodiment of the process according to the invention, the nanofiltration is carried out with the addition of such an amount of water of water that a first retentate having a dilution factor of about 1 to about 10 is obtained and preferably about 3 is obtained. The water from the second permeate P2 of the subsequent reverse osmosis is preferably used in this connection. For the nanofiltration, open-pore membranes have proved to be particularly suitable which have a pore diameter in the range from about 100 to about 1,000 and preferably about 500 to about 800 Dalton.

The material of the filter surface can be stainless steel, polymer materials, ceramics, aluminium oxide or textile fabrics. There are various appearances of the filter elements: candle filters, flat membranes, spiral winding membranes, pocket filters and hollow fibre modules, which are basically suitable in the sense of the present invention. However, spiral winding membranes made of polymer materials or ceramic or aluminium oxide filter filters are preferably used, the first embodiment having proved to be the most suitable for ultrafiltration and the second for nanofiltration. For the purposes of the present invention, the nanofiltration can be “hot” or “cold”, i.e. in the temperature range from about 4 to about 55° C. However, preference is given to working at temperatures in the low range from about 4 to about 25° C. and in particular about 6 to about 15° C.

### Reverse Osmosis

The first permeate P1 of nanofiltration is virtually free of proteins, but contains glucose, galactose and minerals in concentrations which are practically unchanged compared to the starting milk. In the following reverse osmosis, the amount of these two components is concentrated. The reverse osmosis or reverse osmosis is a physical process for the concentration of substances dissolved in liquids, in which the pressure is reversed by the natural osmosis process. The medium in which the concentration of a particular substance is to be reduced is separated by a semipermeable membrane from the medium in which the concentration is to be increased. This is subjected to a pressure which must be higher than the pressure created by the osmotic desire for concentration equalization. This allows the molecules of the solvent to migrate against their “natural” osmotic propagation direction. The process pushes it into the compartment in which solutes are less concentrated.

The osmotic membrane, which only allows the carrier liquid (solvent) to pass through and retains the solutes (solutes), must be able to withstand these high pressures. If the pressure difference more than compensates for the osmotic gradient, the solvent molecules fit like a filter through the membrane, while the remaining molecules are retained. In contrast to a classical membrane filter, osmosis membranes do not have persistent pores. Rather, the ions and molecules migrate through the membrane, diffusing through the membrane material.

The osmotic pressure increases with increasing concentration difference. If the osmotic pressure is equal to the applied pressure, the process stops. There is then an osmotic balance. A continuous drainage of the concentrate can prevent this. At the concentrate outlet, the pressure is either controlled via a pressure regulator or via a pressure exchanger in order to build up the pressure required in the inlet of the system. Pressure exchangers reduce the operating costs of a reverse osmosis system very effectively by energy recovery. The energy consumption per cubic meter of water is 4 to 9 kWh. Preferably, the concentration factor in the process according to the invention is from about 2.5 to about 5 and more preferably from about 3 to about 4.

The crystallization (precipitation) of the solutes in the membranes must be prevented. This can be achieved by the addition of anticaking agents or acids. Antifungal agents here are polymeric compounds based on phosphate or maleic acid, which enclose the crystallites formed and thus prevent the formation of crystalline precipitates on the membrane. However, cleaning the membrane may still be necessary. To prevent damage to the membrane, filters can also be connected upstream. A fine filter can prevent chemical damage (e.g. by chlorine), mechanical and an activated carbon filter.

In the case of reverse osmosis, a second permeate is obtained which essentially represents only water which can be fed back into the nanofiltration, as well as a retentate in which carbohydrates and minerals are contained and which, if appropriate after further concentration (for example by evaporation) has a dry mass of about 10% to about 15% by weight.

### Second Nanofiltration

Alternatively, a second nanofiltration can also take place instead of the reverse osmosis. However, membranes with a pore diameter of about 150 to about 200 Dalton are then preferably used. Permeate and retentate are very similar in composition to the products of reverse osmosis; only the permeate of nanofiltration has a higher content of monovalent salts. This permeate can also be used as a diafiltration medium. Equivalent to nanofiltration is a closed ultrafiltration with membranes which have a similar separation limit as nanofiltration membranes.

### Mixing

The mixing step serves for the production of a standardized milk product, which is subsequently completely freed from lactose by further hydrolysis, if necessary. For this purpose, defined amounts of carbohydrates (glucose and galactose) and minerals are added to the protein-rich first retentate obtained in the first step. The object is in particular to obtain a product which has a correspondingly adjusted sugar concentration opposite the starting milk in order to obtain the same degree of sweetening. The addition of the minerals is also aimed at restoring the original salt concentration and salt composition in order to preserve the taste impression of the milk of origin.

The method according to the invention is therefore further characterized in a specific embodiment by the fact that to the first retentate R1
(i) such an amount of the second retentate R2 is added that a concentration of glucose and galactose of together about 1.0 to about 3.5 weight percent, preferably about 1.5 to about 3.0 weight percent, Based on the resulting standard milk, and/or
(ii) such an amount of the second permeate P2 is added to give a mineral concentration of about 0.6 to about 1.0% by weight, based on the resulting standard milk, and/or
(iii) such an amount of the second permeate P2 is added so that the dilution results in a protein concentration of about 3.0 to about 10.0% by weight, and more preferably about 3.5 to about 3.7% by weight, % Based on the resulting standard milk.

### EXAMPLES

### Example 1

100 kg of milk of the following composition

| Raw milk | Amount (% b.w.) |
|---|---|
| Lactose | 4.0 |
| Proteins | 3.5 |
| Minerals | 0.8 |

were first subjected to a heat treatment at 60° C. over a period of 20 minutes and then, after cooling to 10° C., subjected to a first ultrafiltration with the addition of slide water. The dilution factor was 10, whereby a protein-rich first retentate R1 was obtained as the intermediate product, which had the following composition:

| Retentate R1 | Amount (% b.w.) |
|---|---|
| Lactose | 0.4 |
| Proteins | 11.0 |
| Minerals | 0.08 |

At the same time, a protein-depleted first permeate P1 was obtained which had the following composition:

| Permeate P1 | Amount (% b.w.) |
|---|---|
| Lactose | 4.0 |
| Proteins | <0.1 |
| Minerals | 0.8 |

The first permeate P1 was subjected to reverse osmosis at 10° C. with a concentration factor of 3.5. In this case, a second permeate P2 was obtained, which practically only consisted of (dia-) water, which was fed back into the ultrafiltration step. The second lactose-rich retentate R2 obtained during the reverse osmosis exhibited a dry mass of 18% by weight and the following composition:

| Retentate R2 | Amount (% b.w.) |
|---|---|
| Lactose | 15.5 |
| Proteins | <0.1 |
| Minerals | 2.0 |

The retentate R2 was heated to about 80° C. for about 20 minutes, and the phosphates contained therein were precipitated as calcium phosphate by the addition of calcium/magnesium chloride. The precipitate with the supernatant solution was then cooled to about 25° C. and subjected to a second ultrafiltration, whereby on the one hand a third retentate R 3 having a dry mass of 10% by weight was obtained, which was 90% by weight of calcium and magnesium salts, and a third permeate P3 containing 17% by weight of dry mass of the following composition:

| Permeate P3 | Amount (% b.w.) |
|---|---|
| Lactose | 16.0 |
| Proteins | 0.0 |
| Minerals (Na, K) | 1.0 |

Subsequently, the first retentate R1 was admixed with an amount of the lactose concentrate (Permeate P3) and the salt concentrate (retentate R3) to give a standard milk of the following composition:

| Standard milk | Amount (% b.w.) |
|---|---|
| Lactose | 1.0 |
| Proteins | 3.5 |
| Minerals | 0.8 |

The standardized milk thus had the same protein content and the same amount and composition of minerals as the starting milk, but only about a quarter of the lactose amount. In the subsequent hydrolysis, from 1.0% by weight lactose, 2.0% by weight of glucose and galactose were obtained. In this way, lactose-free milk was obtained which, according to the different sweetening power of the present carbohydrates, had the same degree of sweetening and the same taste profile as the original milk.

### Example 2

100 kg of milk of the following composition

| Raw milk | Amount (% b.w.) |
|---|---|
| Lactose | 4.0 |
| Proteins | 3.5 |
| Minerals | 0.8 |

were first subjected to a heat treatment at 60° C. over a period of 20 minutes and then adjusted to pH=6 in a stirred kettle at 25° C. and treated with such an amount of lactase that a concentration of about 200,000 FCC units/kg of lactose was obtained. After a hydrolysis time of about 3 hours, a product was obtained which had the following composition:

| Product of hydrolysis | Amount (% b.w.) |
|---|---|
| Lactose | <0.1 |
| Glucose | 2.0 |
| Galactose | 2.0 |
| Proteins | 3.5 |
| Minerals | 0.8 |

The hydrolysis product was then subjected to a first nanofiltration with an open-pore membrane with a pore width of 600 Dalton at 10° C. with the addition of water of slide. The dilution factor was 3, the intermediate product being a protein-rich first retentate R1 having the following composition:

| Retentate R1 | Amount (% b.w.) |
|---|---|
| Lactose | <0.1 |
| Glucose | 2.0 |
| Galactose | 2.0 |
| Proteins | 11.0 |
| Minerals | 0.8 |

At the same time, a protein-depleted first permeate P1 was obtained, which had the following composition:

| Permeate P1 | Amount (% b.w.) |
|---|---|
| Lactose | <0.1 |
| Glucose | 2.0 |
| Galactose | 2.0 |
| Proteins | <0.1 |
| Minerals | 0.4 |

The first permeate P1 was subjected to reverse osmosis at 10° C. with a concentration factor of 3.5. This gave a second permeate P2, which consisted essentially of water. The second carbohydrate-rich retentate 2 obtained during the reverse osmosis had a dry mass of about 13% by weight and the following composition:

| Retentate R2 | Amount (% b.w.) |
|---|---|
| Lactose | <0.1 |
| Glucose | 6.0 |
| Galactose | 6.0 |
| Proteins | <0.1 |
| Minerals | 1.2 |

Subsequently, retentate R1 was treated with an amount of carbohydrate-rich retentate R2 and permeate P2, resulting in a standard milk of the following composition:

| Standard milk | Amount (% b.w.) |
|---|---|
| Lactose | <0.1 |
| Glucose | 1.0 |
| Galactose | 1.0 |
| Proteins | 3.5 |
| Minerals | 0.8 |

The standard milk thus had the same protein content as the same amount and composition of minerals as the starting milk, but contained only the corresponding amount of glucose and galactose with which the same sweetness of the starting milk was achieved. In this way, lactose-free milk was obtained which had the same degree of sweetening and the same taste profile as the original milk.

### Example 3

100 kg of milk of the following composition

| Raw milk | Amount (% b.w.) |
|---|---|
| Lactose | 4.0 |
| Proteins | 3.5 |
| Minerals | 0.8 |

were first subjected to a heat treatment at 60° C. over a period of 20 minutes and then adjusted to pH=6 in a stirred kettle at 25° C. and treated with such an amount of lactase that a concentration of about 200,000 FCC units/kg of lactose was obtained. After a hydrolysis time of about 3 hours, a product was obtained which had the following composition:

| Product of hydrolyzation | Amount (% b.w.) |
|---|---|
| Lactose | <0.1 |
| Glucose | 2.0 |
| Galactose | 2.0 |
| Proteins | 3.5 |
| Minerals | 0.8 |

The hydrolysis product was then subjected to a nanofiltration with an open-pore membrane with a pore width of 600 Dalton at 10° C. with the addition of slide water. The dilution factor was 3, the intermediate product being a protein-rich first retentate R1 having the following composition:

| Retentate R1 | Amount (% b.w.) |
|---|---|
| Lactose | <0.1 |
| Glucose | 2.0 |
| Galactose | 2.0 |
| Proteins | 11.0 |
| Minerals | 0.8 |

At the same time, a protein-depleted first permeate P1 was obtained, which had the following composition:

| Permeate P1 | Amount (% b.w.) |
|---|---|
| Lactose | <0.1 |
| Glucose | 2.0 |
| Galactose | 2.0 |
| Proteins | <0.1 |
| Minerals | 0.4 |

The first permeate P1 was subjected to a second nanofiltration at 10° C. with a membrane with a pore width of 150 Dalton with a concentration factor of 3.5. A second permeate P2 was obtained, which consisted essentially of water and alkali salts. The second carbohydrate-rich retentate 2 obtained during nanofiltration had a dry mass of about 13% by weight and the following composition:

| Retentate R2 | Amount (% b.w.) |
|---|---|
| Lactose | <0.1 |
| Glucose | 6.0 |
| Galactose | 6.0 |
| Proteins | <0.1 |
| Minerals | 1.2 |

Subsequently, the first retentate R1 was treated with an amount of the second retentate R2 and the second permeate P2, which resulted in a standard milk of the following composition:

| Standard milk | Amount (% b.w.) |
|---|---|
| Lactose | <0.1 |
| Glucose | 1.0 |
| Galactose | 1.0 |
| Proteins | 3.5 |
| Minerals | 0.8 |

The standardized milk thus had the same protein content as the same amount and composition of minerals as the starting milk. The total amount of carbohydrates (glucose+galactose) was 2% by weight. In this way, lactose-free milk was obtained which had the same degree of sweetening and the same taste profile as the original milk.

### Example 4

100 kg of milk of the following composition

| Raw milk | Amount (% b.w.) |
|---|---|
| Lactose | 4.0 |
| Proteins | 3.5 |
| Minerals | 0.8 |

Were first subjected to a heat treatment at 60° C. over a period of 20 minutes and then subjected to a first ultrafiltration at 10° C. with addition of slide water. The dilution factor was 10, whereby a protein-rich first retentate R1 was obtained as the intermediate product, which had the following composition:

| Retentate R1 | Amount (% b.w.) |
|---|---|
| Lactose | 0.4 |
| Proteins | 11.0 |
| Minerals | 0.08 |

At the same time, a protein-depleted first permeate P1 was obtained, which had the following composition:

| Permeate P1 | Amount (% b.w.) |
|---|---|
| Lactose | 4.0 |
| Proteins | <0.1 |
| Minerals | 0.8 |

The permeate P1 was then subjected to a nanofiltration at a temperature of 10° C. with a membrane having a pore width of 800 Dalton, a second retentate R2 having a dry mass of about 18% by weight and having the following composition:

| Retentate r2 | Amount (% b.w.) |
|---|---|
| Lactose | 13.0 |
| Proteins | <0.1 |
| Minerals | 2.0 |

At the same time, a second permeate P2 was obtained, which consisted of water with a content of 0.3% by weight of salts.

The second retentate R2 was adjusted to pH=6 in a stirred kettle at 25° C. and an amount of lactase was added to give a concentration of about 200,000 FCC units/kg lactose. After a hydrolysis time of about 3 hours, a product was obtained which had the following composition:

| Product of hydrolyzation | Amount (% b.w.) |
|---|---|
| Lactose | <0.1 |
| Glucose | 13.0 |
| Galactose | 13.0 |
| Proteins | <0.1 |
| Minerals | 2.0 |

Subsequently, retentate R1 was admixed with an amount of hydrolysis product and second permeate P2 to give a standardized milk of the following composition:

| Standard milk | Amount (% b.w.) |
|---|---|
| Lactose | <0.1 |
| Glucose | 1.0 |
| Galactose | 1.0 |
| Proteins | 3.5 |
| Minerals | 0.8 |

The standardized milk thus had the same protein content as the same amount and composition of minerals as the starting milk. The total amount of carbohydrates (glucose+galactose) was 2% by weight. In this way, lactose-free milk was obtained which had the same degree of sweetening and the same taste profile as the original milk.

### Example 5, Comparative Examples C1 to C5

Different milk samples which had previously been cooled to 8° C. in the refrigerator were tasted with regard to their taste by a panel consisting of 5 experienced testers and evaluated with regard to sweetness, freshness and mineral taste. The two comparative examples C1 and C2 concern a fresh whole milk as well as a lactose-free whole milk (commercial product). Example 5 according to the invention corresponds to the standard milk from Example 1. The other comparative examples C3 to C5 were carried out with a standard milk according to Example 1, but the temperature pretreatment was dispensed with during preparation (C3), or the temperature treatment at 75° C. for 5 minutes or at 35° C. for 25 minutes (C4, C5). The results are summarized in Table 1; the mean values of the assessments are given.

TABLE 1
Taste evaluation of milk samples

| | | Taste impression | | |
|---|---|---|---|---|
| Ex. | Milk samples | Sweet | Fresh | Minerals |
| C1 | Fresh whole milk, untreated | 4.5 | 9.0 | 3.0 |
| C2 | Fresh whole milk, lactose-free | 7.5 | 5.0 | 4.5 |
| 5 | Standard milk of Example 1 | 5.0 | 8.0 | 3.0 |
| C3 | Standard milk for comparison | 6.0 | 6.0 | 3.5 |
| C4 | Standard milk for comparison | 6.5 | 6.0 | 3.5 |
| C5 | Standard milk for comparison | 6.0 | 5.5 | 3.0 |

The examples and comparative examples clearly demonstrate that only the heat treatment according to the present invention leads to a standard milk comparable with regard to its taste properties with fresh raw milk. Particularly, working without the defined temperature and time interval leads to products which are seriously out of specification demonstrating that the present invention is based on a truly surprising effect.

1. A process for producing a milk product free of lactose comprising the following steps:
(a1) heating raw milk over a period of 5 to 25 minutes at a temperature of from 55 to 65° C. to produce an intermediate;
(a2) subjecting said intermediate of step (a1) to a first ultrafiltration to produce a first permeate UFP1 and a first retentate UFR1;
(a3) subjecting said first permeate UFP1 to reverse osmosis to produce a second permeate ROP2 and a second retentate ROR1;
(a4) subjecting second retentate ROR1 to decalcification;
(a5) subjecting said decalcification product of step (a4) to a second ultrafiltration to produce a third permeate UFP3 rich in lactose and a third retentate UFR3 rich in minerals,
(a6) mixing said first retentate UFR1 with such amount of said third permeate UFP3 to produce standard milk showing a lactose content of less than 0.1% b.w. and a mineral and protein content similar to said raw milk; and optionally
(a7) subjecting said standard milk of step (a6) to hydrolysis by addition of lactase in an amount sufficient to convert all remaining lactose into glucose and galactose;
or
(b1) subjecting standard milk to hydrolysis by addition of lactase in an amount sufficient to convert about 25 to about 100% of its lactose content into glucose and galactose;
(b2) heating said hydrolyzation product of step (b1) over a period of 5 to 25 minutes at a temperature of from 55 to 65° C. to produce an intermediate;
(b3) subjecting said intermediate to nanofiltration to produce a first permeate NFP1 and a first retentate NFR1;
(b4) subjecting said first permeate NFP1 either to reverse osmosis or another nanofiltration to produce a second permeate RO/NFP1 and a second retentate RO/NFR2;
(b5) mixing said first retentate NFR1 with such amount of said third permeate RO/NFP3 to produce standard milk showing a lactose content of less than 0.1% b.w. and a mineral and protein content similar to said raw milk; and optionally
(b6) subjecting said standard milk of step (a6) to hydrolysis by addition of lactase in an amount sufficient to convert all remaining lactose into glucose and galactose;
or
(c1) heating raw milk over a period of 5 to 25 minutes at a temperature of from 55 to 65° C. to produce an intermediate;
(c2) subjecting said intermediate of step (a1) to a first ultrafiltration to produce a first permeate UFP1 and a first retentate UFR1;
(c3) subjecting said first permeate UFP1 to nanofiltration to produce a second permeate NFP2 and a second retentate NFR1;
(c4) subjecting said second retentate NFR1 to hydrolysis by adding lactase in an amount sufficient to convert about 25 to about 90% of its lactose content into glucose and galactose;
(c5) mixing said first retentate UFR1 with such amount of said second permeate NFP2 and said hydrolyzation product of step (c4) to produce standard milk showing a lactose content of less than 0.1% b.w. and a mineral and protein content similar to said raw milk; and optionally
(c6) subjecting said standard milk of step (c5) to hydrolysis by addition of lactase in an amount sufficient to convert all remaining lactose into glucose and galactose.

2. The process of claim 1 wherein said raw milk is full milk, skim milk or standard milk.

3. The process of claim 1 wherein said raw milk shows lactose content of about 3 to about 5% b.w.

4. The process of claim 1 wherein ultrafiltration is conducted with such an amount of water that the retentate thus obtained shows a dilution factor of about 5 to about 15.

5. The process of claim 4, wherein said water represents the permeate of a reverse osmosis process.

6. The process of claim 1 wherein said ultrafiltration is conducted using membranes showing an average pore diameter of from about 1,000 to about 50,000 Dalton.

7. The process of claim 1 wherein said each ultrafiltration independently from the other is conducted at a temperature of from about 4 to about 25° C.

8. The process of claim 1 wherein said reverse osmosis is conducted by applying a concentration factor of about 2.5 to about 5.

9. The process of claim 1 wherein said decalcification is conducted by adding calcium or magnesium salts.

10. The process of claim 1 wherein said decalcification is conducted at temperatures of from about 50 to about 90° C. and/or over a period of from about 10 to about 60 minutes.
